(19) United States
(12) Patent Application Publication
(10) Pub. No.: US 2023/0030807 A1
(43) Pub. Date: Feb. 2, 2023

(54) DERIVING METROLOGY DATA FOR AN INSTANCE OF AN OBJECT

(71) Applicant: Hewlett-Packard Development Company, L.P., Spring, TX (US)

(72) Inventors: Stephen Bernard Pollard, Bristol (GB); Faisal Azhar, Bristol (GB)

(73) Assignee: Hewlett-Packard Development Company, L.P., Spring, TX (US)

(21) Appl. No.: 17/786,624

(22) PCT Filed: Jan. 7, 2020
(86) PCT No.: PCT/US2020/012464

§ 371 Date: Jun. 17, 2022

(51) Int. Cl. G06T 19/20; G06T 17/20; B29C 64/393

(52) U.S. Cl. CPC G06T 19/20; G06T 17/20; B29C 64/393; B33Y 50/02

(57) ABSTRACT

A method is described in which a three-dimensional polygon mesh model of an object is analysed to identify a sub-mesh representing a predefined geometric shape. The polygon mesh model is aligned with three-dimensional scan data of an instance of the object. Based on the alignment, the position of the predefined geometric shape is identified in the three-dimensional scan data. Using the position of the predefined geometric shape, metrology data for the instance of the object is derived from the three-dimensional scan data.

A three-dimensional object may be produced using a manufacturing process, such as an additive manufacturing process which involves generating the object on a layer-by-layer basis. Such objects are often manufactured according to a three-dimensional model. Once manufactured, it is often useful to obtain data such as measurements of the object. Such measurements may be assessed against the three-dimensional to model to give an indication of the accuracy of the instance of the objection and/or the manufacturing process.

### BRIEF DESCRIPTION OF THE DRAWINGS

Examples of the disclosure are further described hereinafter with reference to the accompanying drawings, in which:

FIG. 1 is a flowchart of a method for deriving metrology data according to an example;

FIG. 2 is a block diagram of an augmented polygon mesh model according to an example;

FIG. 3 is a flowchart of an example of a block of the method of FIG. 1;

FIG. 4 is a block diagram of inputs to a block of the method of FIG. 1;

FIG. 5 is an example of a three-dimensional model of an object;

FIG. 6 is a polygon mesh representation of the three-dimensional model of FIG. 5;

FIG. 7 is the polygon mesh representation of the three-dimensional model of FIG. 6, with significant planes identified;

FIG. 8 is representation of the significant planes of the three-dimensional model of FIG. 5;

FIG. 9 is a representation of a three-dimensional scan of an object manufactured according to the three-dimensional model of FIG. 5;

FIG. 10 is a point cloud representation of the three-dimensional scan of FIG. 9;

FIG. 11 is a representation of the significant planes identified in the three-dimensional scan of the object;

FIG. 12 is representation of the scan of the object, combining the point cloud of FIG. 10 and the representation of FIG. 11;

FIG. 13 is a block diagram of an example apparatus according to the disclosure;

FIG. 14 is block diagram of a further example apparatus according to the disclosure;

FIG. 15 is a schematic of an example machine-readable medium with a processor;

FIG. 16 is a flow diagram of a method for deriving metrology data according to another example

FIG. 17 is a flow diagram of a block of the method of FIG. 16;

FIG. 18 is a representation of an outcome of the method of FIG. 16;

FIG. 19 is a representation of a further outcome of the method of FIG. 16; and

FIG. 20 is a is a schematic of an example machine-readable medium with a processor.

### DETAILED DESCRIPTION

Additive manufacturing techniques may generate a three-dimensional object through the solidification of a build material. In some examples, the build material may be a powder-like granular material, which may for example be a plastic, ceramic or metal powder. Build material may be deposited, for example on a print bed and processed layer by layer, for example within a fabrication chamber. Other manufacturing techniques, including for example subtractive manufacturing, casting, injection moulding and machining, may also be used to generate three-dimensional objects. Additive manufacturing may be referred to as three-dimensional printing.

Manufacturing systems, such as additive manufacturing systems, may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

A three-dimensional object may be represented in terms of a set of vertices, edges and faces. Such a representation may be referred to as a polygon mesh, or a polygon mesh model. An example of a polygon mesh is a triangle mesh, where each of the faces are triangular in shape. Typically, the structural design data of a three-dimensional model, for example, from a CAD system, may be transformed into a polygon mesh model for processing in the actual manufacturing process. The polygon mesh model generated from a CAD model may further comprise other information about surface properties and appearance of the object. A polygon mesh model may be represented in a referential scheme as a list of vertices, faces and possibly edges, where each face consists of the indices of the included vertices (or edges which in turn refence the vertices). A polygon mesh model may be represented such that the vertex geometry could be explicit in each face. That is, each polygonal face could be represented as an N×3 matrix where each row of the matrix represents the X, Y and Z coordinates of the N vertices in the face (where N=3 for a triangular mesh). One limitation of this representation is that the mesh adjacencies are not made explicit as they are in the referential scheme where faces are deemed neighbours if they share a common vertex reference (in fact in such a scheme each vertex may have a link to a list of neighbouring faces). However, in certain referential polygon mesh models, the vertices are repeated for each polygonal face for which they are a part and hence the explicit relationships are lost.

Once an instance of an object has been manufactured according to a three-dimensional model, it is often desirable to measure the manufactured instance to assess the accuracy of the manufactured instance and the manufacturing process. For objects that will be mass manufactured, it is possible to design bespoke measuring systems to take the desired measurements. However, for some manufacturing techniques such as additive manufacturing, the number of objects that will be manufactured is often small.

Implementing bespoke metrology systems for such objects is impractical, both in relation to time and cost. Furthermore, known methods of specifying the desired accuracy of a manufactured article may not take into account issues that may arise in the process of additive manufacturing.

Furthermore, in an additive manufacturing process, it may also be useful to deduce certain process control parameters of the manufacturing process. In some applications, this information may be more useful than specific measurements of the instance of the object. For additive manufacturing, it is useful to obtain the print process parameters such as scale and offset measurements of the instance of the object. Process control parameters may be derived from the print process parameters. The process control parameters may then be used of to correct the geometry of the printing process through either updates to the additive manufacturing apparatus calibration parameters or individualized pre-compensation of the specific part.

Obtaining a three-dimensional scan of the instance of the object is used to assess the manufactured object. Analysis of the scan of the instance of the object in comparison with the model can be used to provide information on the accuracy of the manufacturing process and the process control parameters of the manufacturing process.

However, the instance of the object does not necessarily conform to the three-dimensional model from which it was created due to deformations inherent in the additive manufacturing process.

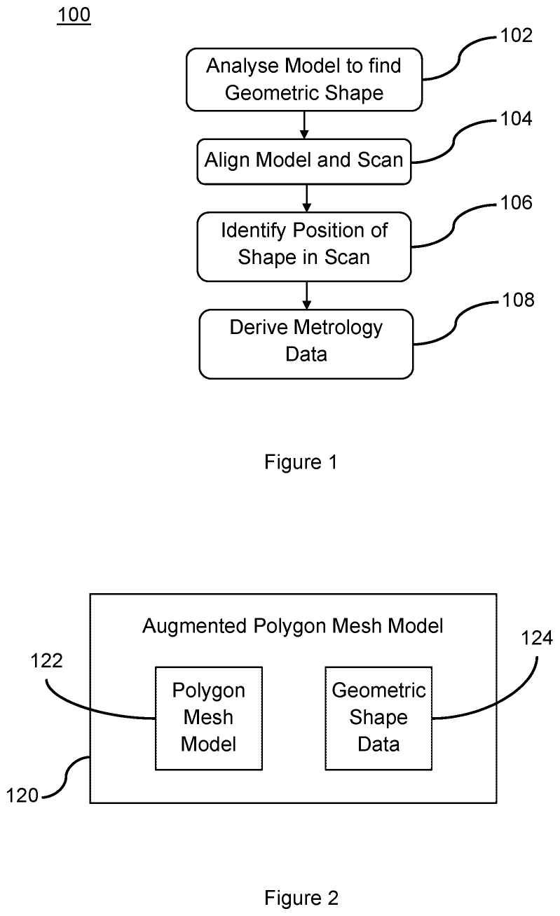

Referring now to FIG. 1, there is shown a flow chart of a method, indicated generally by the reference numeral 100, for deriving metrology data for an instance of an object manufactured according to a three-dimensional model. At block 102, the method 100 comprises analysing a three-dimensional polygon mesh model of an object to identify at least one sub-mesh representing at least one predefined geometric shape. At block 104, the method 100 comprises aligning the polygon mesh model with three-dimensional scan data of an instance of the object. At block 106, the method 100 comprises identifying the position of the at least one predefined geometric shape in the three-dimensional scan data based on the alignment. At block 108, the method comprises using the position of the at least one predefined geometric shape to derive metrology data for the instance of the object from the three-dimensional scan data. Obtaining metrology data in this manner is efficient and provides improved performance.

Referring now to FIG. 2, there is shown a block diagram of an augmented polygon mesh model 120 according to the disclosure. The augmented polygon mesh model 120 comprises the polygon mesh model 122 and the geometric shape information 124 derived in block 102 of the method 100 of FIG. 1.

The method 100 provides for fully automated model-based metrology, with improved accuracy and flexibility over what is available from the known alternatives. The object measurement process can be fully automated. Generating an object-specific inspection routine can be avoided, which is advantageous in relation to manufacturing small numbers of objects, and/or highly customisable manufacturing processes. There is no requirement for defining specific datums within the three-dimensional model. The estimated geometric shapes in the scan data allow recovery of measurements such as the separation and relative orientation of the geometric shapes in the instance of the object. The measurements available from the method are not limited to critical dimensions of the object, but all aspects of the instance of the object may be measured. The measurements can be further analysed to provide automatic print control parameters such as scale and offset which can in turn be fed back into a manufacturing process to optimise or control the manufacturing process.

Scale and offset may be referred to as non-rigid deformation occurring in the instance of the object. Each part has roughly constant scale and offset but it may change depending where on a print bed of a 3D printer the part is printed. The method 100 described herein may be used to identify deformations such as scale, offset, and errors in the relative orientation of the geometric shapes.

The method 100 may also be useful in determining other errors and deformations occurring in the instance of the object. Such other deformations may include sink in the upper surface of parts. Such sink may be the result of meniscus that forms as the instance of the object cools from molten to a solid state. Sink can be measured in terms of the deviation of the points that constitute a plane from the fitted plane. Identifying the extent of the sink may allow the process control parameters to be adjusted to reduce or eliminate the error in future instances of the object. The method 100 may also be useful identifying “elephant skin” or wrinkles on the surface of the instance of the object. Additionally, the method 100 may identify large form errors in the instance of the object, for example, deviation from flatness in a plane, or deviation from sphericity of a sphere.

It will be understood that the methods taught herein have advantages in relation to a variety of manufacturing processes such as injection moulding or subtractive manufacturing, but are also useful in relation to an additive manufacturing process.

When aiming to identify a geometric shape in scan data of an object, carrying out an analysis of the polygon mesh model of the object is more efficient than analysing the scan data of an instance of an object. The polygon mesh model does not include the noise that may be present in scan data; and comprises a much smaller number of data points. This more concise geometric representation of the augmented model leads to a reduced processing load.

In the analysing block 102, the polygon mesh model of the object is automatically analysed to identify sub-meshes that correspond to certain geometric shapes that may be present in the object. The geometric shapes may also be referred to as geometric primitives, as they may be considered to represent a form or shape from which the shape of the object is composed. No user input is required to determine the geometric shapes of interest in the three-dimensional model of the object. Furthermore, there are no additional design steps in the creating the three-dimensional model to facilitate identifying the geometric shapes, for example, there is no design input required to identify or specify reference locations in the model. The block 102 may identify one, some, or all instances of one particular geometric shape, or may identify one, some, or all instances of a selection of geometric shapes. Such shapes may include planes, including irregularly shaped planes and regularly shaped planes; curved shapes such as spheres and cylinders; and additional shapes representing combinations of planar shapes and curved shapes, for example polyhedrons such as tetrahedrons, cubes, cuboids, and prisms. Generally, if a shape can be modelled, examples of that shape can be identified in the polygon mesh model.

Analysing the polygon mesh model to identify at least one sub-mesh representing a geometric shape may comprise identifying the at least one sub-mesh according to a stored definition. Suitable definitions that may be stored include a definition of a plane, a definition of a sphere, a definition of a cylinder, a definition of a cuboid, a definition of another polyhedron or other polyhedrons, and other definitions. In general, the identification of the sub-meshes will be automatic with no user input required, however, in certain examples, a user may choose which geometric shapes to search for in the polygon mesh model. In a polygon mesh model with meshes with vertices repeated for each polygonal face for which they are a part, the method may comprise pre-processing the polygon mesh model to combine repeated vertices and their references in the polygons of the mesh.

An analysis of the polygon mesh model may be directed to identifying significant planes within the object. A plane may be identified as a connected sub-mesh where the faces within the sub-mesh share a normal direction. Identifying significant planes may include identifying sub-meshes where faces within the sub-mesh have an area above a certain threshold. For example, a suitable threshold area may be 10 mm² for an object of linear dimension 100 mm. Identifying significant planes may include identifying sub-meshes where faces within the sub-mesh have an aspect ratio below a certain value, here the aspect ratio is defined as the ratio of the longest and shortest orthogonal dimensions of the sub-mesh defining the plane. For example, a suitable aspect ratio may be 5. It will be understood that these thresholds may be scaled as the dimensions of the object are scaled.

An analysis of the polygon mesh model may be directed to identifying significant spheres or regular cylinders within the object. A sphere may be defined by four non-planar vertices in the polygon mesh model. For each face within the polygon mesh model of the object, a subset of four neighbouring or included non-planar vertices may be recruited that can be used to calculate the centre and radius for a sphere on whose surface that subset of vertices is located. Once the parameters (centre and radius) of the sphere have been calculated, other vertices in the augmented polygon mesh may be tested for agreement with the calculated parameters. The distance of the vertex points from the centre is calculated and compared to the radius of the sphere. If that distance is within a threshold, the vertex is considered to be located on the sphere surface. For each face in the polygon mesh model, possible spheres including that face are determined by identifying sets of neighbouring or included non-planer vertices that define a sphere, and then checking remaining vertices for inclusion in that sphere. Multiple potential spheres may be analysed for the face. This process is repeated for each face in the polygon model mesh. Significant spheres or sphere portions are identified in the augmented polygon mesh model as a sub-mesh of connected faces that form the surface of the sphere or sphere portion. Spheres or sphere portions may be considered significant if the surface area and solid angle of the sphere is above a certain threshold. The solid angle may be approximated from the sum of the areas of the faces of the sub-mesh divided by the radius squared. For a sphere portion, those having a solid angle larger than a π/2, representing ⅛^{th} of a complete sphere, may be considered significant. As previously, a minimum threshold surface area of 10 mm² may be applied to the surface area of the sphere itself.

Cylinders may be identified in the polygon mesh model in a similar manner. Cylinders may be defined by five or six non-planar points. For each face in the polygon mesh model, neighbouring vertices are analysed to check for their ability to define a cylinder. If a potential cylinder is identified, the remaining vertices are checked to see if they form part of the surface of that cylinder. For a cylinder, the perpendicular distance from the vertex point to the axis of the cylinder is to be calculated, rather than the distance used for the sphere. Cylindrical sub-meshes may be considered significant if their length along the axis of the cylinder is significant with respect to its radius and their surface area is above a threshold. For example, a surface area above 10 mm² for an object of overall linear dimension 100 mm would be a suitable threshold for significance.

Once the sub-meshes representing the geometric shapes have been identified the polygon mesh model is augmented with the geometric shape data to provide an updated polygon mesh model, which may also be referred to as an augmented polygon mesh model. The augmented mesh model consists of the original polygon mesh model and a list of geometrical primitives, each of which includes an array of references to the constituent polygon faces. Each element in the list of geometrical primitives make explicit their form, for example plane, sphere, cylinder, and the like, and also includes any relevant parameters. The faces and by reference the included vertices of each identified geometric shape may be referenced according to the geometric shape instance of the augmented polygon mesh model. In this way, the processing of the polygon mesh model to generate the augmented polygon mesh model may be considered a classification process, where each vertex and face for a particular geometric shape are classified into a category or group.

In the aligning block 104, the augmented polygon mesh model is aligned with the three-dimensional scan data. The scan data may be represented as a polygon mesh; as a point cloud of data points on the surface of the scanned object; or in another suitable format. If using a point cloud representation, the three-dimensional scan data may comprise the locations of a plurality of three-dimensional points on the surface of the instance of the object. Scan data in the form of a polygon mesh may include the locations of three-dimensional vertex points on the surface of the instance of the object and the edges connecting the vertex points. The scan data may be obtained in any suitable manner. Obtaining the scan data may include combining multiple three-dimensional scans of multiple views of the instance of the object, however useful metrology results may be obtained from scan data obtained from a single view. The aligning may comprise providing an approximate alignment between the three-dimensional model and the three-dimensional scan data. As such, the alignment between the polygon mesh model and the scan data may be considered an approximate alignment. For example, the alignment may be accurate to within 1 mm and 1°. The aligning block 104 adjusts the three-dimensional scan data to bring it into the same coordinate frame system as the augmented polygon mesh model. An approximate alignment is acceptable as it is used as a starting point from which to identify the geometric shapes in the scan data. The alignment allows the recruitment of three-dimensional points in the scan data with respect to each of the geometric shapes identified in the augmented polygon mesh model. Examples of mesh and point cloud alignment are (Winkelbach, S., Molkenstruck, S., and Wahl, F. M. (2006), Low-cost laser range scanner and fast surface registration approach, In Pattern Recognition, pages 718-728. and Azhar, F., Pollard, S. and Adams, G. (2019) ‘Gaussian Curvature Criterion based Random Sample Matching for Improved 3D Registration’ at VISAPP) but it will be understood that the alignment described herein is not limited to these examples.

In block 106 of method 100, the position of the geometric shapes in the augmented polygon mesh model are identified in the scan data. Identifying the position of the at least one geometric shape in the three-dimensional scan data may comprise associating a selection of the three-dimensional scan points with the geometric shape closest thereto. As such, the selected three-dimensional points of the scan data are associated with the closest geometric shape of the augmented polygon mesh model. The identifying process may be understood to refer to a recruitment process where a selection of points in the scan are recruited into each geometric shape. Each scan point is associated with its closest polygon in the augmented polygon mesh model. For those faces in the scan data that are identified as belonging to geometrical shapes in the augmented data, the scan points that are associated with them are thus associated with the corresponding geometrical shape instance. Identifying the position of the at least one geometric shape in the three-dimensional scan data may further comprise processing the three-dimensional scan points associated with a geometric shape in the polygon mesh model to locate a corresponding geometric shape in the three-dimensional scan data.

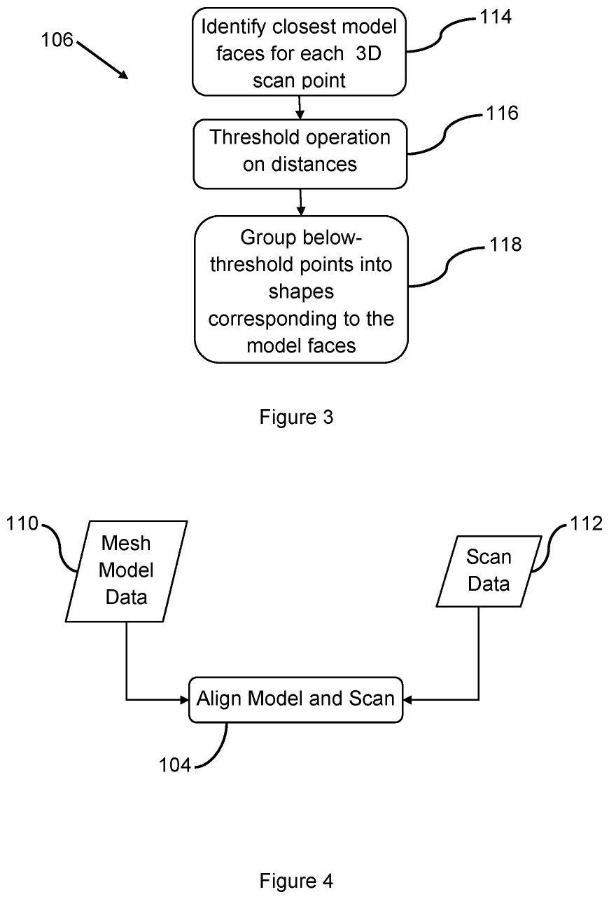

FIG. 3 shows an example implementation of block 106 including three sub-blocks. In sub-block 114, the distance from some or all of the three-dimensional points in the scan data to the polygonal faces of the polygon mesh model are calculated. Next, in sub-block 116, a threshold operation is carried out to identify the closest polygon faces for each scan point that are within a closest distance threshold. The scan points corresponding to each face may be further restricted to include only those whose perpendicular to the face lies within the boundary of the polygon of the face. Then the three-dimensional points in the scan data with sub-threshold distance are thus grouped as geometric shapes corresponding to the geometric shapes identified in the augmented polygon mesh model, based on the face in the mesh model to which the three-dimensional scan point was closest.

In block 108, metrology data for the instance of the object is derived from the scan data using the information relating to the geometric shapes. In a first example, this comprises calculating measurements of features in the instance of the object from the scan data. Knowing the location of the identified geometric features in the scan data allows those geometric shapes to be used as references for taking the measurements. A feature may be understood to refer to a part of a geometric shape, or the distance between geometric shapes, and other physical aspects of the object. Measurements may be taken between two separate shapes, or within a single shape. For example, in the case where the geometric shapes comprise a pair of parallel planes, the distance between the planes may be measured; where the geometric shape is a single plane, the deviation of the three-dimensional scan points from a plane may be measured, and so on. As a further example, where the geometric shape is a sphere, the dimensions of a sphere could be measured, or distance from the centre or surface of the sphere to another feature of the object.

In a second example of the derivation of metrology data in block 108, using the position of the at least one geometric shape to derive metrology data comprises calculating the scale and offset parameters of the manufacturing process for the instance of the object. The printed object may be scaled differentially in the x, y and z directions with respect to the print bed and each of these scales may differ from the unity value that allows the instance of the object to be printed at its specified size. These scale parameters can be garnered from the appropriate components of measurements between recovered geometrical primitives. The offset may also be referred to as the erosion and dilation of the surface material. For example, the thickness of the walls of a printed object may all be too thick if the offset is in the form of a dilation or too thin if the offset is in the form of an erosion. The size of the offset may also differ in each of the x, y and z directions. For a situation where the object is manufactured through additive manufacturing, on a print bed, and the object is aligned with the x, y, z axes of the print bed, it is possible to directly calculate the scale and offset by solving a simple linear relationship. In each dimension, scale and offset are the gradient and offset in the following linear equation:

yᵢ=xᵢm+oᵢc (1)

where xᵢ and yᵢ are the model and scanned data measurements for this axis respectively; oᵢ is an offset inclusion parameter that is set to 1 where the two faces involved in a measurement are faces with opposite polarity and 0 otherwise, m is the gradient (scale) and c the offset (dilation/erosion of the surface material). The above equation can be represented as a system of equations,

$$Y = [ \begin{matrix}X & O\end{matrix} ] [ \begin{matrix}m \\ c\end{matrix} ] \qquad ( 2 )$$

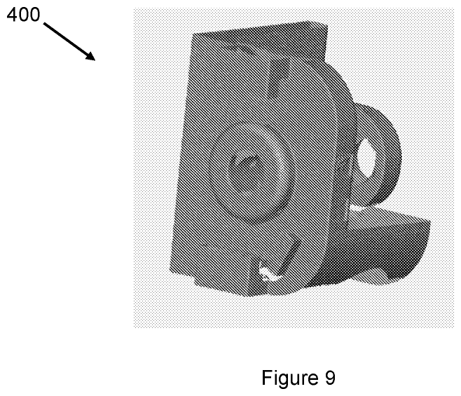

which may be solved using a linear least squares method. Similar equations can be used in the case where the planes are not directly aligned with major axis of the printer. In the case of the 3D scanned data 400 shown in FIG. 9, scale in the X direction is 1.004 with an offset of −0.104 mm.

One type of measurements may include an offset, this type may be considered as “calliper type” measurements, for example between a pair of planes of opposite polarity or estimates of the diameter of a sphere. A second type of measurement does not include an offset, for example step heights where both surfaces have the same offset and it is not discernible, or distances between sphere centres.

Analysing the three-dimensional polygon mesh of the model to determine the geometric shapes may be done separately to the remaining blocks of the method 100.

FIG. 4 is a block diagram showing the data inputs to the aligning block 104. The aligning block 104 receives an augmented polygon-mesh model 110 in which one or more geometric shapes have been identified. It further receives the three-dimensional scan data 112 of the manufactured instance of the object.

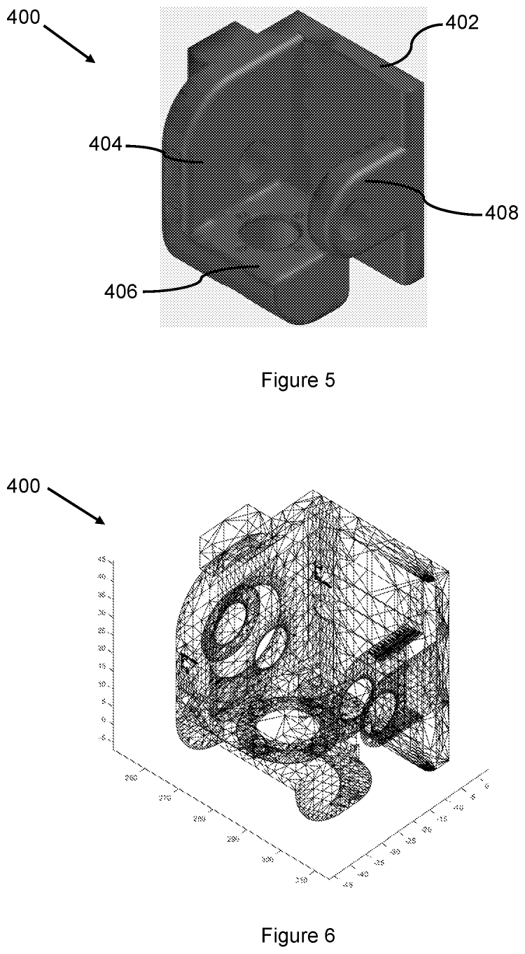

Referring now to FIGS. 5 to 12, there is illustrated an example according to the method 100 disclosed herein. FIG. 5 shows a three-dimensional model of an object, in this case an extruder bracket 400. The extruder bracket comprises a substantially square backplate 402 having a side plate 404, a base plate 406, and a side arm 408 extending therefrom. The side plate 404, base plate 406, and side arm 408 all project orthogonally from the back plate 402. The back plate 402, side plate 404 and side plate are arranged as x, y and z axes. The side plate 404 has free corner which is curved. The side plate 404 and side plate 408 are substantially parallel to each other, extending from opposite edges of the back plate. Each of the side plate 404 and side arm 408 have a circular through-hole, where both through-holes are co-axial and of the same diameter. The base plate has a further through-hole of larger diameter that the side through-holes.

Referring now to FIG. 6, there is shown the polygon mesh representation of the extruder bracket 400. The vertices, edges and faces of the augmented polygon mesh for the extruder bracket 400 can be seen. For this example, the geometric shape used for analysis of the polygon mesh model for the extruder bracket 400 was a plane.

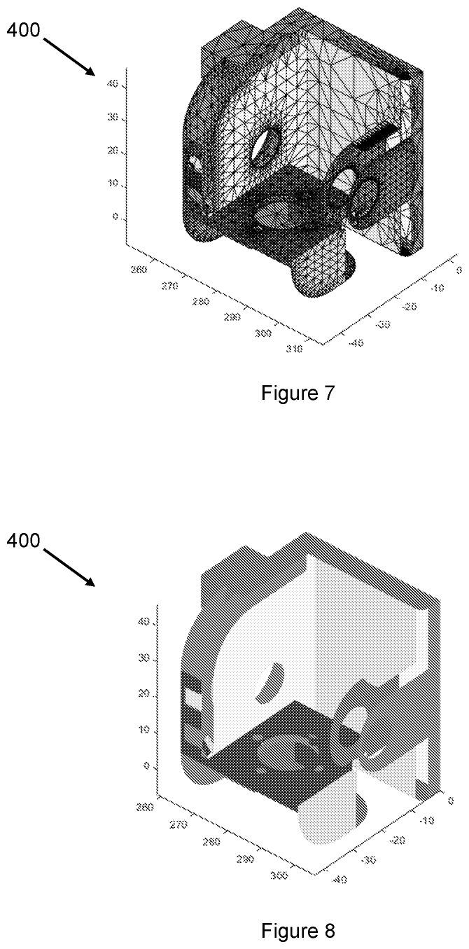

Referring now to FIG. 7, there is shown the polygon mesh representation of the extruder bracket 400, with significant planes identified. Connected faces of the polygon mesh model having the same normal direction have been grouped together into planes. The planes correspond to the surfaces of the various components of the extruder bracket 400. The augmented polygon mesh model may further comprise data grouping the planes according to co-planarity; common surface normal; planes having the same normal but in the opposite direction, which may be referred to as opposite polarity. Other suitable classifications and groupings may be applied as appropriate to other geometric shapes identified in an example object.

Referring now to FIG. 8, there is shown a representation of the significant planes of the extruder bracket 400, as identified in the augmented polygon mesh model.

The representation of FIG. 6 corresponds to that of FIG. 7, without the vertices and edges of the polygon mesh.

Referring now to FIG. 9, there is shown a representation of a three-dimensional scan of the extruder bracket 400 manufactured according to the three-dimensional model of FIG. 4. This representation shows a reverse angle of the extruder bracket 400.

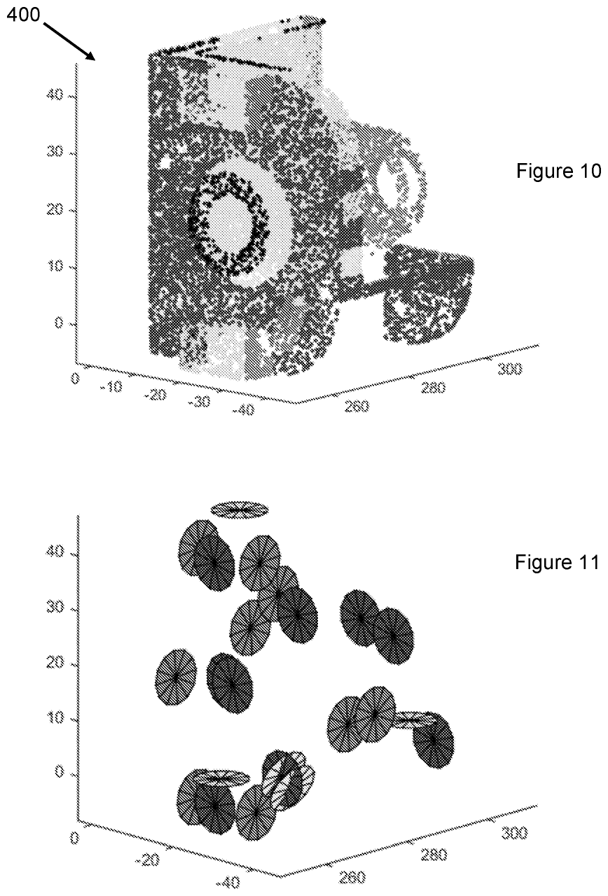

After the scan data is aligned with the polygon mesh data, a sub-set of points from the scan data is selected. FIG. 10 is a point cloud representation of the three-dimensional scan of FIG. 9. In the example shown in FIG. 10, a random selection of 1% of the points of the point cloud were chosen for analysis. FIG. 10 shows that subset of points, colour coded into their corresponding planes with respect to polygon mesh model FIG. 7. An automatic plane fitting process is performed on the selected points in the scan data that have been associated with corresponding CAD planes. For the points grouped into each nominal plane, those groups of planes at the same nominal orientation may be combined for a multi-plane fit. This may comprise categorising the significant planes are categorised according to co-planarity, common surface normal, and opposite planarity. An example plane fitting method may use an iterative weighted least squares version of M-Estimation with a Turkey weighting function to eliminate any outlier points that may have been incorrectly included in a plane due to the approximate alignment of the model and scan data.

FIG. 11 is a representation of the significant planes identified in the three-dimensional scan of the object, wherein each estimated or fitted plane is represented as a disc, having an orientation corresponding to the estimated orientation of the plane and with its centre located at the estimated centre of gravity of the plane.

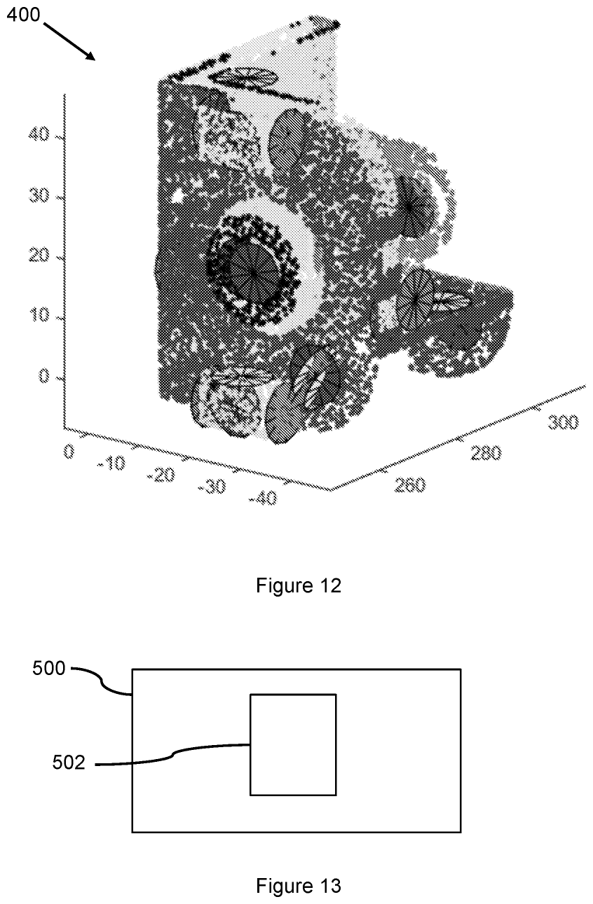

FIG. 12 is representation of the scan of the object, combining the point cloud of FIG. 10 and the representation of FIG. 11. In FIG. 11, the discs of FIG. 11 have been superimposed on the point cloud and plane data of FIG. 10.

Based on grouped planar measurements, it is possible to obtain metrology data for the object, for example by computing individual plane-to-plane measurements, such as the perpendicular distance between the planes. It is also possible to measure the relative orientation of non-grouped planes. These measurements may then be compared with corresponding measurements from the three-dimensional model for an indication of accuracy of the instance of the object.

It may be helpful when fitting planes to ignore regions close to the edge of the plane by shrinking the individual planes that form the polygon mesh model. This introduces a guard band around the points that are recruited form a specific plane and makes it less likely to recruit points belonging to adjacent surfaces in the presence of small residual misalignment of the polygon mesh model against the scanned point cloud. If a second candidate plane with a further degree of shrink factor (larger than the first) is also sought, then the difference between the fitted planes in the direction of a common normal will be indicative of the degree of sink present in the printed plane.

According to some examples, an apparatus may be controlled to perform the method 100 discussed above. FIG. 13 is a simplified schematic of an example of an apparatus 500 for deriving metrology data for the instance of the object from a scan of the instance of the object. The apparatus 500 may comprise processing circuitry 502. The processing circuitry 502 may determine at least one sub-mesh representing at least one predefined geometric shape in a three-dimensional polygon mesh model of an object by performing an analysis of the three-dimensional polygon mesh model. In some examples, the processing circuitry 502 may perform an alignment between the three-dimensional polygon mesh model and three-dimensional scan data of an instance of the object. The processing circuitry 502 may determine, based on the alignment, the position of the at least one predefined geometric shape in the three-dimensional scan data. The processing circuitry 502 may obtain metrology data for the instance of the object from the three-dimensional scan data using the position of the at least one predefined geometric shape. In some examples, the processing circuitry 502 may obtain metrology data by calculating measurements of features in the instance of the object. Additionally or alternatively, the processing circuitry 502 may calculate the scale and offset parameters for the instance of the object, and may further derive from the scale and offset parameters, process control parameters for an additive manufacturing process that manufactured the instance of the object. This is an efficient method of obtaining these process control parameters.

The processing circuitry 502 may comprise circuitry within a computing device, which may form part of, or be associated with, an additive manufacturing apparatus.

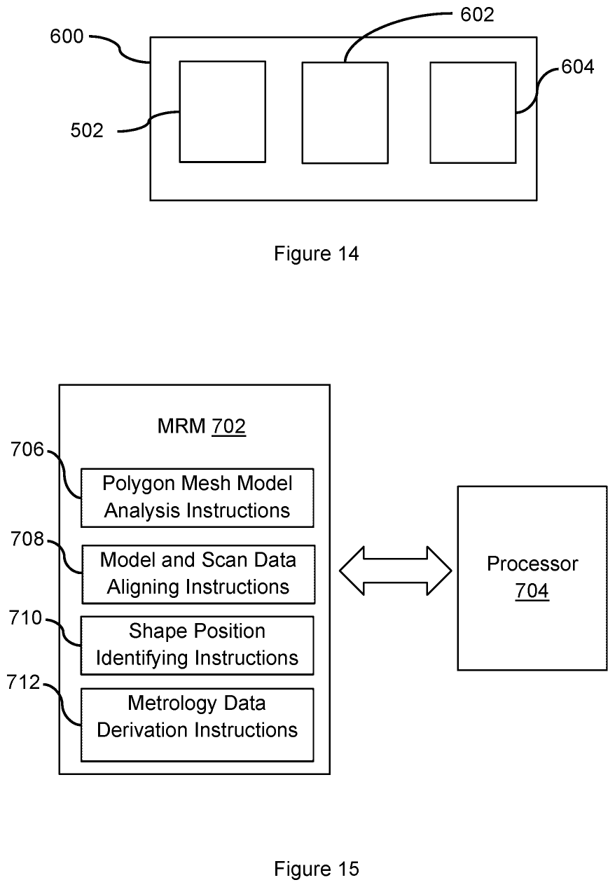

FIG. 14 is a simplified schematic of an example of an apparatus 600 for deriving metrology data for the instance of the object. The apparatus 600 may comprise the processing circuitry 502. In some examples, the apparatus 600 may further comprise a user input device 602 to enable a user to select the geometric shapes to be identified in the polygon mesh model. The user input device 602 may, for example, comprise a keyboard, a mouse, a touchpad or a touchscreen.

The apparatus 600 may, in some examples, comprise a storage medium 604 to store details of the polygon mesh model, the augmented polygon mesh model, the scan data, the locations of geometric shapes within the scan data; and other information relevant to the methods and examples disclosed herein.

In some examples, the apparatus 600 may comprise processing circuitry 502 to analyse a three-dimensional polygon mesh model of an object to identify at least one sub-mesh representing at least one predefined geometric shape; align the polygon mesh model with three-dimensional scan data of an instance of the object; based on the alignment, identify the position of the at least one predefined geometric shape in the three-dimensional scan data; and use the position of the at least one predefined geometric shape to derive metrology data for the instance of the object from the three-dimensional scan data.

FIG. 15 is a schematic of an example machine-readable medium 702 with a processor 704. The machine-readable medium 702 may comprise instructions which, when executed by a processor 704, cause the processor to perform the method 100 discussed above. The machine-readable medium 702 may comprise instructions which, when executed by a processor 704, cause the processor to identify at least one sub-mesh representing at least one predefined geometric shape in a three-dimensional polygon mesh model of an object by performing an analysis of the three-dimensional polygon mesh model. The machine-readable medium 702 may comprise polygon mesh model analysis instructions 706 to perform the analysing.

The machine-readable medium 702 may comprise instructions which, when executed by a processor 704, cause the processor to perform an alignment between the three-dimensional polygon mesh model and three-dimensional scan data of an instance of the object. The machine-readable instructions may comprise model and scan data aligning instructions 708 to perform the alignment.

The machine-readable medium 702 may comprise instructions which, when executed by a processor 704, cause the processor to identify, based on the alignment, the position of the at least one predefined geometric shape in the three-dimensional scan data. The machine-readable medium 702 may comprise shape position identifying instructions to identify the position of the shape.

The machine-readable medium 702 may comprise instructions which, when executed by a processor 704, cause the processor to derive metrology data for the instance of the object from the three-dimensional scan data using the position of the at least one predefined geometric shape. The machine- readable medium 702 may comprise metrology data derivation instructions 712 to derive the data.

In some examples, the machine-readable medium 702 may comprise additional instructions which, when executed by a processor 604, cause the processor to perform further actions in line with the methods and examples described herein.

In some examples, the machine-readable medium 702 may comprise instructions, which when executed by the processor 704, cause the processor 704 to analyse a three-dimensional polygon mesh model of an object to identify at least one sub-mesh representing at least one predefined geometric shape; align the polygon mesh model with three-dimensional scan data of an instance of the object; based on the alignment, identify the position of the at least one predefined geometric shape in the three-dimensional scan data; and use the position of the at least one predefined geometric shape to derive metrology data for the instance of the object from the three-dimensional scan data.

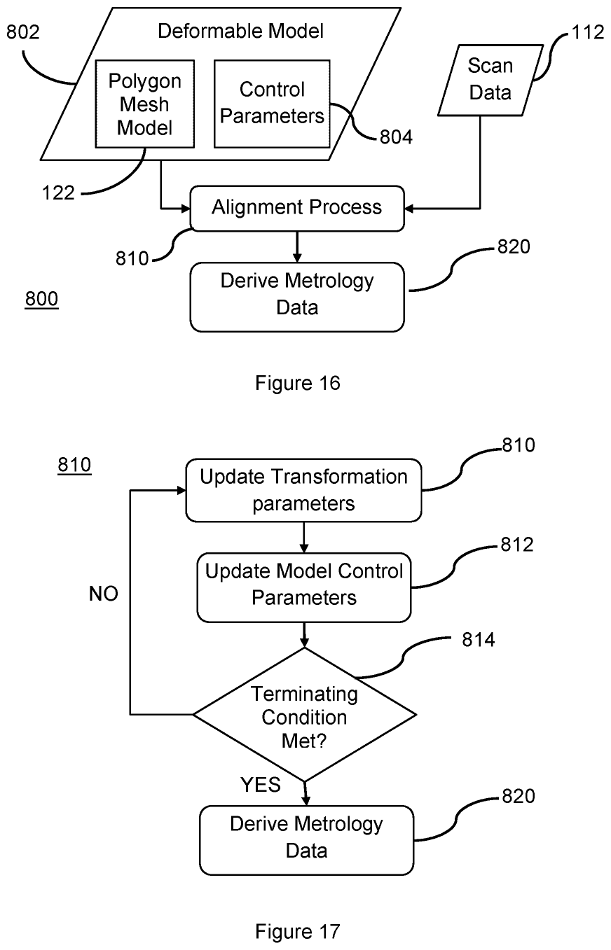

Referring now to FIGS. 16 to 20, there is disclosed a further method of deriving metrology data for an instance of an object based on a three-dimensional model thereof. In the example described herein in relation to these figures, there is disclosed a method of deriving metrology data based on a method of aligning a polygon mesh model of an object with a scan data of an instance of that object. This example may be used in conjunction with or separately from the previously described method.

FIG. 16 is a flow diagram of a method 800 for deriving metrology data according to another example. The method 800 provides automated model-based metrology. The method 800 operates on a deformable model 802 comprising a polygon mesh model 122 of an object and a set of control parameters 804 for adjusting the shape of the polygon mesh model 122. In one example, the parameters comprise the scale and offset parameters for the object, but other parameters may be included. At block 810, there is provided an alignment process for aligning the deformable model 802 with the three-dimensional scan data 112. The aligning comprises an iterative process for identifying transformation parameters that relate the three-dimensional scan data 112 to the deformable three-dimensional model 802, wherein the iterative process further comprises updating the set of control parameters 804 so as to optimise alignment between the three-dimensional model 802 and the three-dimensional scan data 112. The iterative update procedure simultaneously adjusts both the transformation parameters that relate the three-dimensional scan data 112 to the polygon mesh model 122, and the control parameters 804 of the deformable model 802 in order to minimize the overall geometric error that relates the two. This allows the direct recovery of control parameters of the print process, from their model control parameter counterparts. Furthermore, any residual errors are easier to interpret, as they ignore the main modes of variation that are modelled in the system. Once the deformable model 802 and the three-dimensional scan data 112 have been aligned, it is possible to derive metrology data, in block 820 of the method 800, relating to the instance of the object. In particular, the final control parameters of the deformable model provide the scale and offset of the instance of the object. The deformable model can deform in a controlled fashion in order to more precisely register the polygon mesh model 122 against the three-dimensional scan data 112 and directly measure the scanned part based on the fitted control parameters of the deformable model 802. The control parameters may also be referred to as the deformation parameters.

FIG. 17 is a flow diagram of the alignment process block 810 of the method 800 of FIG. 15. This alignment process is based on Iterative Closest Point (ICP) methodology that can be used to align the mesh models to scan data. Example systems start with an approximate alignment between the model and scanned meshes and operate iteratively to improve the alignment. At each iteration, a number of nearest neighbour, i.e. closest points, matches are sought between points in the respective mesh and scan data. Such matches can be between the three-dimensional points in each the mesh and the scan data, if treating both the model and the scan data as simple point clouds; or between three-dimensional points in the scan data and the nearest point on the mesh surface itself in the other. The former is referred to as point to point matching while the latter is referred to a point to plane, as ultimately the mesh surface is represented by a set of planar polygonal surface facets. The matches may be used to refine the geometric transformation parameters, i.e. rotation and translation, that aligns the scan data to the model. This process uses a least squares or weighted least squares approach and is often referred to as total least squares or orthogonal regression as the goal is to minimize the Euclidian distances between the data points.

In the alignment block 810 of the method 800, sub-block 810 comprises updating the transformation parameters discussed above. In sub-block 812, the control parameters 804 of the deformable model 802 are also updated. The control parameters 804 of the deformable model 802 are updated to allow the deformable model 802 to better reflect the shape of the instance of object. Next in sub-block 814, the method 810 checks to see if a terminating condition has been met. If not the method 810 proceeds through another iteration. Once the terminating condition has been met, the method of subblock 810 reverts to the main method 800 and the desired metrology data is derived. The terminating condition may be when a predefined number of iterations has been completed; or when the changes occurring are smaller than a predefined threshold, for example the largest single point change in the model; or another suitable terminating condition.

The method 800 described in relation to FIGS. 16 and 17 provide for the automation of the part measurement process. This automatic metrology method eliminates the requirement for designing and implementing part-specific inspection routines. This method further provides direct recovery of the process control parameters. The measurements facilitated by the method are not limited to certain critical dimensions, as the method allows measurement of all aspects of an object manufactured according to a three-dimensional model. The method provides improved accuracy over prior art systems.

The method 800 described in relation to FIGS. 16 and 17 allow identification of deformations such as scale, offset and errors in the relative orientation of the geometric shapes; and other errors and deformations occurring in the instance of the object such as large form errors, sink, “elephant skin”, or wrinkling on the surface. The ICP method 800 of FIGS. 16 and 17 can work on any shape. It generalizes the ability to get process control parameters for customer specific parts.

In an example, at each iteration of the ICP, once the transformation parameters have been calculated, they are applied to the selected points from the three-dimensional scan data 112. Next, as part of that iteration, the relative scale of deformable model 802 to the three-dimensional scan data 112 is estimated. For an additive manufacturing process, it may be desirable to separately estimate the X, Y and Z scale with respect to the print bed of the manufacturing apparatus, as such it is convenient to assume that the deformable model 802 is orientated accordingly. The deformable model 802 can also be arranged to be centred at the origin of the coordinate space to allow scale and offset parameters to be measured about it. Alternatively, the centre of gravity of each the deformable model 802 and scan data 112 can be subtracted at each iteration prior to estimating scale and offset parameters.

In each dimension, scale and offset are the gradient and normal direction dependent offset in the following linear relationship

yᵢ=xᵢm+nᵢc (3)

where xᵢ and yᵢ are the model and scanned data measurements for this axis respectively; nᵢ is the relevant component of the surface normal for this point, m is the gradient (scale) and c the offset (dilation/erosion of the surface material). The above equation can be represented as a system of equations,

$$Y = [ \begin{matrix}X & N\end{matrix} ] [ \begin{matrix}m \\ c\end{matrix} ] \qquad ( 4 )$$

which may be solved using a linear least squares method. It is possible to choose to make the scale and/or offset common for X, Y and Z or to carry out separate analyses.

There is an option to apply weights to each row of this system to make the solution more robust. These can be based on either/both the magnitude of the component of the surface normal in the relevant (X, Y, or Z) direction and/or the size of residual error in the point to point correspondences. It is also possible to separate out offsets in the positive and negative directions in each dimension to recover different offset parameters

$$Y = [ \begin{matrix}X & {N}_{+} & {N}_{-}\end{matrix} ] [ \begin{matrix}m \\ {c}_{+} \\ {c}_{-}\end{matrix} ] \qquad ( 5 )$$

In an alternative example, the combined alignment and scale/offset computation can be carried out at each iteration of the ICP process. In this way, a joint transformation of the three-dimensional scan data and control parameters, such as scale and offset, of the deformable model 802 is calculated to minimise the combined geometric error between the pair at each stage of the ICP. It is advantageous that the three-dimensional scan data continues to be transformed onto the deformable model 802 while the deformable model 802 is updated to reflect the additive manufacturing process. This may include scaling it separately along the X, Y and Z print axes. This update can be performed using non-linear gradient assent over a weighted sum of square Euclidean distance metric using a standard numerical optimization routine such as the “fminsearch” routine function of Matlab using six parameters to specify the transformation matrix (three rotation, such as Euler angles; and three translation), three scale parameters and as many offset parameters as desired.

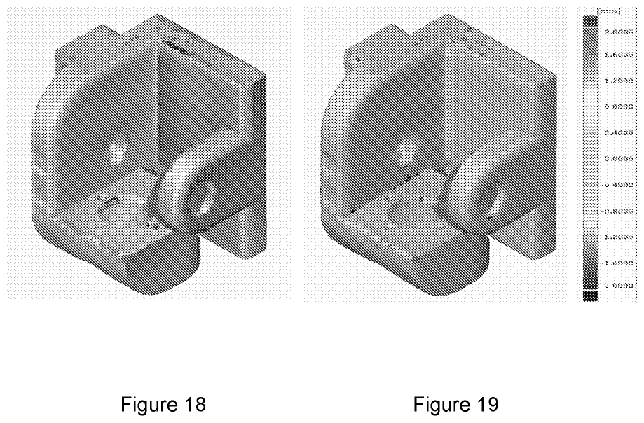

Referring now to FIGS. 17 and 18, there is shown a representation of the deformable model and the three-dimensional scan data, respectively, of the extruder bracket previously described in relation to FIG. 5.

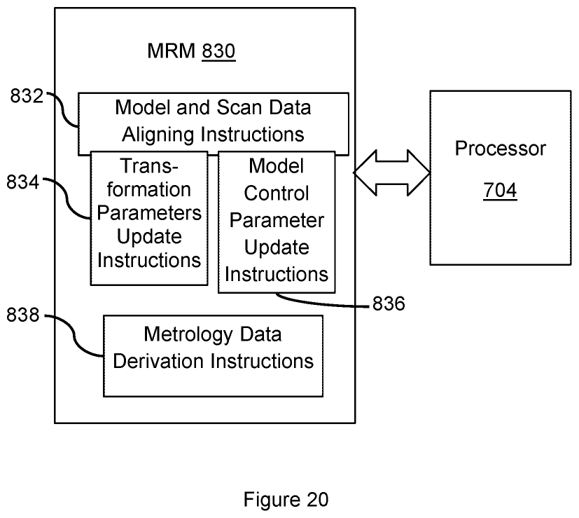

FIGS. 19 and 20 show representations of the instance of the object illustrating the residual error between the original polygon mesh model of FIG. 17, and the three-dimensional scan data 112. The residual error is colour coded according to the scale on the right.

FIG. 18 shows the results of a prior art analysis based on alignment only, that is, the result of an alignment process based on deriving and iteratively adjusting the transformation parameters only.

FIG. 19 shows the results of the application of the method 800 comprising iteratively updating both the transformation parameters and the control parameters of the deformable model 802. Results of the linear method, which updates the transformation parameters and control parameters separately, and the non-linear method which updates all parameters in unison, are very similar for this data, with recovered scale and offset for the linear approach of Scale: X=0.9458, Y=0.9933, Z=0.9929 Offset: X=0.2783, Y=1.2344, Z=0.1062 and for the non-linear Scale: X=0.9471, Y=0.9963, Z=0.9935 Offset: X=0.2467, Y=1.2159, Z=0.1159.

Each of FIGS. 18 and 19 shows the size of alignment between the CAD mesh and its closest point on the aligned scan data. The size of error is shown as a false colour according to the scale to the right of FIG. 19. While the error in FIG. 18 is dominated by the mismatch between the scale and offset differences between the polygon mesh model and the scan data with many parts showing considerable errors of a millimetre or more, the error in FIG. 19 is generally very small as the scaling parameters have been applied to the CAD mesh to produce better overall alignment.

FIG. 20 is a schematic of a further example of a machine-readable medium 830 with the processor 704. The machine-readable medium 830 may comprise instructions which, when executed by a processor 704, cause the processor to perform the method 800 described in relation to FIGS. 16 and 17 discussed above. The three-dimensional polygon mesh model is part of a deformable three-dimensional model with a set of control parameters for adjusting the shape of the model. The machine-readable medium 830 may comprise instructions which, when executed by a processor 704, cause the processor to implement an iterative alignment process for identifying transformation parameters that relate the three-dimensional scan data to the three-dimensional model. The machine-readable medium 830 may comprise model and scan data aligning instructions 832 to perform the aligning. Furthermore, the machine-readable medium 830 may comprise instructions which, when executed by a processor 704, cause the processor to update the set of control parameters so as to optimise alignment between the three-dimensional model and the three-dimensional scan data. The machine-readable medium 830 may comprise instructions which, when executed by a processor 704, cause the processor to, as part of the aligning process, iteratively update the transformation parameters. The machine-readable medium 830 may further comprise instructions which, when executed by a processor 704, cause the processor to, as part of the aligning process, iteratively update the model control parameters. The model and scan data aligning instructions 832 may comprise transformation parameters update instructions 834 and model control parameter update instructions 836 to carry out the updating.

The machine-readable medium 830 may comprise instructions which, when executed by a processor 704, cause the processor to use the position of the at least one predefined geometric shape to derive metrology data for the instance of the object from the three-dimensional scan data. The machine- readable medium 830 may comprise metrology data derivation instructions 834 to derive the data.

In some examples, the machine-readable medium 830 may comprise additional instructions which, when executed by a processor 704, cause the processor to perform further actions in line with the methods and examples described herein.

Examples in the present disclosure can be provided as methods, systems or machine-readable instructions, such as any combination of computer programme code, hardware, or the like. Such machine-readable instructions may be included on a machine-readable medium having computer readable program codes therein or thereon. The machine-readable medium can be realised using any type or volatile or non-volatile (non-transitory) storage such as, for example, memory, a ROM, RAM, EEPROM, optical storage and the like. The machine-readable medium may be a non-transitory machine-readable medium. The machine-readable medium may also be referred to as a computer-readable storage medium.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by processing circuitry. The processing circuitry, for example the processing circuitry 502 referred to in relation to FIGS. 12 and 13 may be in the form of or comprised within a computing device. Such a computing device may include a general purpose computer, a special purpose computer, an embedded processor or processors or other programmable data processing devices to realize the functions described in the description and diagrams. In particular, a processor or processing apparatus may execute the machine-readable instructions. Thus, functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure. The methods and examples taught herein provide for fully automated model-based metrology, with improved accuracy and flexibility than over what is available from the known alternatives. The object measurement process can be fully automated. This automatic metrology method eliminates the requirement for designing and implementing part-specific inspection routines, which is particularly advantageous in relation to manufacturing small numbers of objects, and/or highly customisable manufacturing processes. There is no requirement for defining specific datums within the three-dimensional model. The measurements available from the method are not limited to critical dimensions of the object, but all aspects of the instance of the object may be measured. The measurements can be further analysed to provide automatic print control parameters such as scale and offset, which can in turn be fed back into a manufacturing process to optimise or control the manufacturing process. The methods may also allow identification of other deformations such as sinks, and surface deformations such as wrinkling.

While the methods and systems described herein in relation to FIGS. 16 to 20 may be used independently to derive metrology data in relation to an instance of an object, they may also be used in conjunction with the methods and systems previously described herein in relation to FIGS. 1 to 15. For example, some parts of an object may be modelled as geometric primitives while others cannot be. In this case, a mixture of the approaches is used to calculate the scale and offset at each iteration. The contribution from the geometric primitives would be constant but the contribution from the rest would depend on the ICP process.

While the method, apparatus and related aspects have been described with reference to certain examples, various modifications, changes, omissions, and substitutions can be made without departing from the scope of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

Throughout the description and claims, a number of threshold values have been identified and example values provided. It will be understood that threshold values other than those suggested in the examples may be used and will still fall within the scope of the disclosure.

The features of any dependent claim may be combined with the features of any of the independent claims or other dependent claims.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise. A single processor or other unit may fulfil the functions of several units recited in the claims.

The reader's attention is directed to all papers and documents which are filed concurrently with or previous to this specification in connection with this application and which are open to public inspection with this specification.

1. A method comprising
analysing a three-dimensional polygon mesh model of an object to identify at least one sub-mesh representing at least one predefined geometric shape,
aligning the polygon mesh model with three-dimensional scan data of an instance of the object;
based on the alignment, identifying the position of the at least one predefined geometric shape in the three-dimensional scan data; and
using the position of the at least one predefined geometric shape to derive metrology data for the instance of the object from the three-dimensional scan data.

2. The method as claimed in claim 1 wherein using the position of the at least one geometric shape to derive metrology data comprises calculating measurements of features in the instance of the object.

3. The method as claimed in claim 1 wherein using the position of the at least one geometric shape to derive metrology data comprises calculating the scale and offset parameters for the instance of the object.

4. The method as claimed in claim 3 comprising deriving, from the scale and offset parameters. process control parameters for an additive manufacturing process that manufactured the instance of the object.

5. The method as claimed in claim 1 wherein the three-dimensional scan data comprises a polygonal mesh including the locations of a plurality of vertex points on the surface of the instance of the object, and identifying the position of the at least one geometric shape in the three-dimensional scan data comprises associating a selection of the three-dimensional scan points with the geometric shape closest thereto.

6. The method as claimed in claim 5 wherein identifying the position of the at least one geometric shape in the three-dimensional scan data further comprises processing the three-dimensional scan points associated with a geometric shape in the polygon mesh model to locate a corresponding geometric shape in the three-dimensional scan data.

7. The method as claimed in claim 1 wherein the aligning comprises providing an approximate alignment between the three-dimensional model and the three-dimensional scan data.

8. The method as claimed in claim 7 wherein the alignment is accurate to within 1 mm and 1 degree.

9. A method as claimed in claim 1 wherein the geometric shape is a plane.

10. The method as claimed in claim 1 wherein the instance of the object was manufactured according to an additive manufacturing process.

11. The method as claimed in claim 1 wherein analysing the polygon mesh model to identify at least one sub-mesh representing a geometric shape comprises identifying the at least one sub-mesh according to a stored definition.

12. An apparatus comprising processing circuitry to:
determine at least one sub-mesh representing at least one predefined geometric shape in a three-dimensional polygon mesh model of an object by performing an analysis of the three-dimensional polygon mesh model;
perform an alignment between the three-dimensional polygon mesh model and three-dimensional scan data of an instance of the object;
determine, based on the alignment, the position of the at least one predefined geometric shape in the three-dimensional scan data; and
obtain metrology data for the instance of the object from the three-dimensional scan data using the position of the at least one predefined geometric shape.

13. A machine-readable medium comprising instructions, which when executed by a processor, cause the processor to:
identify at least one sub-mesh representing at least one predefined geometric shape in a three-dimensional polygon mesh model of an object by performing an analysis a three-dimensional polygon mesh model;
performing an alignment between the three-dimensional polygon mesh model with three-dimensional scan data of an instance of the object;
identify, based on the alignment, the position of the at least one predefined geometric shape in the three-dimensional scan data; and
derive metrology data for the instance of the object from the three-dimensional scan data, using the position of the at least one predefined geometric shape.

14. The method as claimed in claim 1 wherein the three-dimensional polygon mesh model is part of a deformable three-dimensional model with a set of control parameters to adjust the shape of the model, and the aligning comprises an iterative process to identify transformation parameters that relate the three-dimensional scan data to the three-dimensional model, wherein the iterative process further comprises updating the set of control parameters so as to optimise alignment between the three-dimensional model and the three-dimensional scan data.

15. The method as claimed in claim 4 further comprising recovering the process control parameters of the manufacturing process from the control parameters.
